(19) United States
(12) Patent Application Publication
(10) Pub. No.: US 2025/0296263 A1
(43) Pub. Date: Sep. 25, 2025

(54) CUTTING APPARATUS

(71) Applicant: Honda Motor Co., Ltd., Tokyo (JP)

(72) Inventors: Hiroki Kato, Tokyo (JP); Hideaki Onda, Tokyo (JP); Kazutoshi Mameda, Tokyo (JP); Shinsuke Onishi, Tokyo (JP); Kazuma Fujiwara, Tokyo (JP)

(21) Appl. No.: 19/060,925

(22) Filed: Feb. 24, 2025

(30) Foreign Application Priority Data
Mar. 22, 2024 (JP) 2024-046879

(51) Int. Cl. B26D 7/18; B26D 1/09

(52) U.S. Cl. CPC B26D 7/1854; B26D 1/095; B26D 7/1863

(57) ABSTRACT

A cutting apparatus including a placing table, a first and second workpiece pressing portions, and a blade portion moving up and down in thickness direction of the workpiece between the first and second workpiece pressing portions. The blade portion includes a first blade surface extending upward from a tip of the blade portion and facing the first workpiece pressing portion, and a second blade surface extending along the second workpiece pressing portion from the tip of the blade portion. The cutting apparatus includes a blow part supplying blow gas to a region around the tip of the blade portion through a gap between the first blade surface and the first workpiece pressing portion, and a suction part sucking gas in the region around the tip of the blade portion through a gap between the second blade surface and the second workpiece pressing portion.

### CROSS-REFERENCE TO RELATED APPLICATION

This application is based upon and claims the benefit of priority from Japanese Patent Application No. 2024-046879 filed on Mar. 22, 2024, the content of which is incorporated herein by reference.

### BACKGROUND OF THE INVENTION

### Field of the Invention

This invention relates to a cutting apparatus.

### Description of the Related Art

Conventionally, a cutting apparatus for cutting sheet-shaped workpieces is known. For example, International Publication No. 2022/045828 (WO 2022/045828 A) discloses a cutting apparatus for cutting an electrode sheet in the process of manufacturing a unit electrode for a lithium secondary battery.

By the way, when a sheet-shaped workpiece is cut by a cutting apparatus, cutting residue of the workpiece may occur at the time of cutting. This cutting residue may adhere to a blade of a cutter and fall on the workpiece. In a case where the cutting residue adhering to the blade falls on a work region to be used as a product, there is a possibility of causing a defect if the workpiece is incorporated into the product. For example, if the cutting residue falls on an electrolyte membrane when a CP (carbon paper) material on which the electrolyte membrane is formed is cut, the cutting residue sticks into the electrolyte membrane, and it is difficult to remove the cutting residue even when cleaning using a gas is performed.

### SUMMARY OF THE INVENTION

An aspect of the present invention is a cutting apparatus including: a placing table on which a workpiece formed in a plate shape is placed; a first workpiece pressing portion configured to press a first workpiece region of the workpiece toward the placing table; a second workpiece pressing portion provided to be separated from the first workpiece pressing portion in an extending direction of the workpiece and configured to press a second workpiece region of the workpiece toward the placing table; and a blade portion configured to move up and down in a predetermined direction corresponding to a thickness direction of the workpiece between the first workpiece pressing portion and the second workpiece pressing portion to cut the workpiece. The blade portion includes a first blade surface extending in the predetermined direction from a distal end of the blade portion and facing the first workpiece pressing portion, and a second blade surface extending along the second workpiece pressing portion from the distal end of the blade portion and facing the second workpiece pressing portion. The cutting apparatus further includes a blow part configured to supply a blow gas to a region around the distal end of the blade portion through a gap between the first blade surface and the first workpiece pressing portion, and a suction part configured to suck a gas in the region around the distal end of the blade portion through a gap between the second blade surface and the second workpiece pressing portion.

### BRIEF DESCRIPTION OF THE DRAWINGS

The objects, features, and advantages of the present invention will become clearer from the following description of embodiments in relation to the attached drawings, in which:

FIG. 1 is a diagram schematically illustrating an example in which a workpiece is cut by a cutting apparatus according to an embodiment of the present invention;

FIG. 2 is a diagram illustrating a configuration of a main part of the cutting apparatus according to the embodiment of the present invention;

FIG. 3 is an enlarged view of a blade portion in FIG. 2;

FIG. 4 is a view illustrating a configuration of the blade portion and its surrounding area in a state where the blade portion is located at an elevation upper end position;

FIG. 5 is a view illustrating a state where a lower surface of an outer periphery pressing portion comes into contact with the workpiece;

FIG. 6 is a view illustrating a state where a lower surface of an inner periphery pressing portion comes into contact with the workpiece;

FIG. 7 is view illustrating a state where the blade portion is located at an elevation lower end position;

FIG. 8 is an enlarged view of a cutting location in the cut state illustrated in FIG. 7;

FIG. 9 is an enlarged view of the blade portion and its surrounding area in the state illustrated in FIG. 3;

FIG. 10 is an enlarged view of the blade portion and its surrounding area in the state illustrated in FIG. 5;

FIG. 11 is an enlarged view of the blade portion and its surrounding area in the state where the blade portion is located at the elevation upper end position;

FIG. 12 is a view illustrating an example of the workpiece; and

FIG. 13 is a view illustrating a placing table in which a suction flow path and a suction hole are provided.

### DETAILED DESCRIPTION OF THE INVENTION

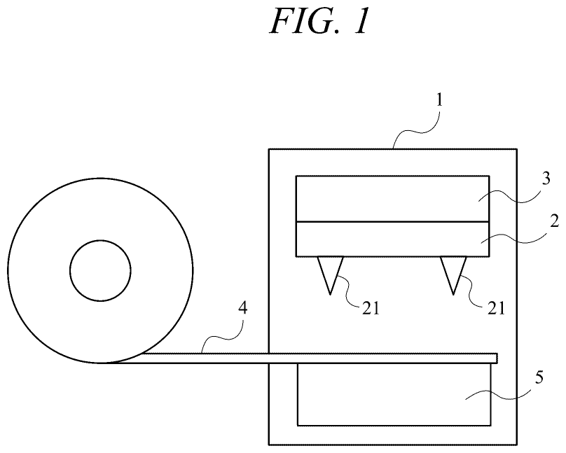

FIG. 1 is a diagram schematically illustrating an example in which a workpiece is cut by a cutting apparatus according to an embodiment of the present invention. As illustrated in FIG. 1, the cutting apparatus 1 includes an upper part 3 to which a cutting blade 2 is fixed. A blade portion 21 for cutting a workpiece 4 is formed on a lower surface of the cutting blade 2. Examples of the workpiece 4 include a sheet member in which a carbon paper (CP) material used for a gas diffusion layer of a fuel cell and a carrier film are bonded to each other. The thickness of the CP layer is about several hundred um, and the thickness of the workpiece 4 including the carrier film is about 1 mm. Examples of the workpiece 4 include a workpiece in which a micro porous layer (MPL) layer is provided on a CP material and a workpiece in which an electrode is further provided on the MPL layer on the CP material. The sheet-shaped workpiece 4 wound in a roll shape is drawn out onto a placing table 5 of the cutting apparatus 1 and cut (for example, trimmed), whereby the workpiece 4 is cut to form a CP material for a product having a predetermined shape.

Hereinafter, as an example, a case will be described in which the sheet-shaped workpiece 4 is trimmed into a rectangular shape, but the processing shape is not limited to the rectangular shape. In addition, in the following description, the workpiece 4 of the CP material to be cut by the cutting apparatus 1 will be described as an example, but the workpiece 4 to be cut is not limited to the CP material of the fuel cell, and various workpieces can be applied as long as it is a sheet-shaped workpiece.

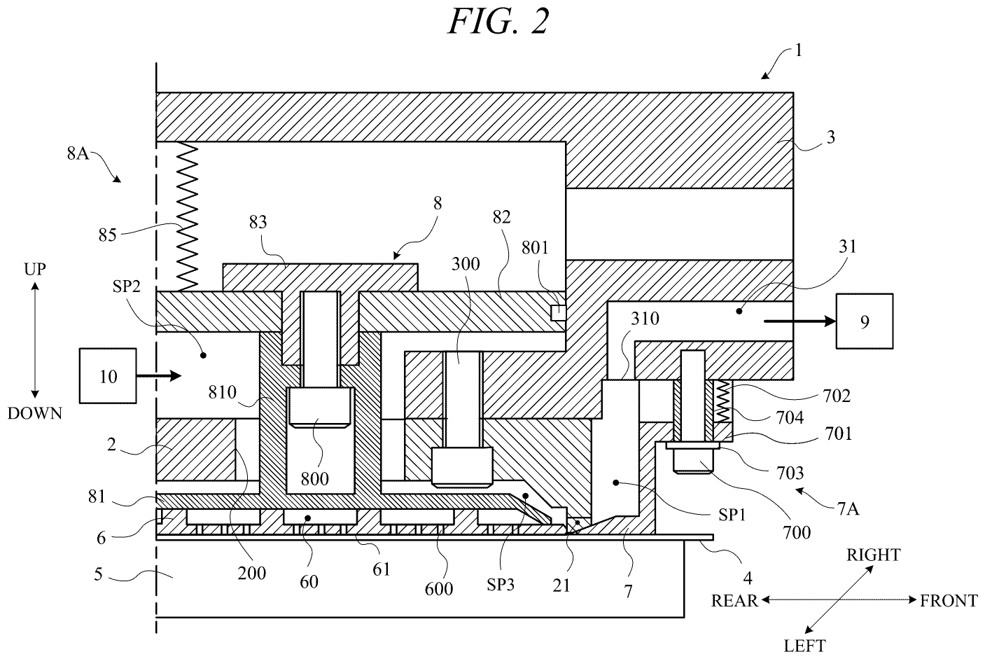

FIG. 2 is a diagram illustrating a configuration of a main part of the cutting apparatus 1 according to the embodiment of the present invention. Hereinafter, directions orthogonal to each other as illustrated in the drawing are defined as a front-rear direction, a left-right direction, and an up-down direction, and a configuration of each unit will be described according to such definitions. The up-down direction is, for example, a gravity direction, and the front-rear direction and the left-right direction are, for example, a horizontal direction.

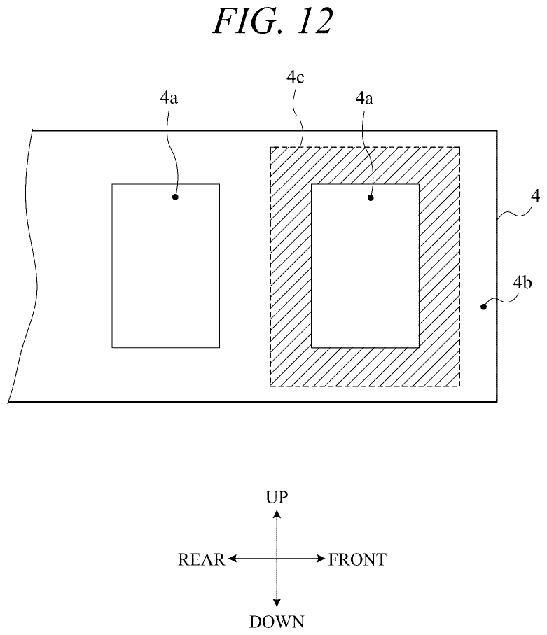

As illustrated in FIG. 2, the cutting blade 2 is fixed to the lower surface of the upper part 3 with a bolt 300. As will be described later, the blade portion 21 of the cutting blade 2 moves up and down in a plate thickness direction of the workpiece between an inner periphery pressing portion 6 and an outer periphery pressing portion 7 to cut the workpiece 4. The outer periphery pressing portion 7 is a jig that presses an excess region, which does not become a product in the work region, toward the placing table 5, and is attached to the lower surface of the upper part 3 with a bolt 700. For example, as illustrated in the plan view of the workpiece of FIG. 12, in a case where a rectangular product region 4a is cut from the workpiece 4, the inner periphery pressing portion 6 presses the product region 4a toward the placing table 5. On the other hand, the outer periphery pressing portion 7 presses, toward the placing table 5, a hatched excess region 4c of the region 4b excluding the product region 4a. As illustrated in FIG. 2, a spring 702 is interposed between a flange portion 701 of the outer periphery pressing portion 7 and the upper part 3. A cylindrical spacer 704 is provided between a washer 703 and the upper part 3. The spring 702 is a compression spring, and the outer periphery pressing portion 7 is biased downward by the spring 702. The bolt 700, the spring 702, and the like constitute a support portion 7A (second support portion) that supports the outer periphery pressing portion 7 so as to be movable in the up-down direction.

A suction flow path 31 is formed in the upper part 3. The suction flow path 31 is connected to a suction device 9 such as a vacuum pump. A suction opening 310 at one end of the suction flow path 31 is provided on the lower surface of the upper part 3, and the suction flow path 31 communicates with a space SP1 between the cutting blade 2 and the outer periphery pressing portion 7 via the suction opening 310. The suction flow path 31 connected to the suction device 9, and the blade portion 21 and the outer periphery pressing portion 7 forming the space SP1 and a gap G2 function as a suction mechanism that constantly sucks the gas in the region around the distal end of the blade portion 21 and the region of a blade surface 212.

The inner periphery pressing portion 6 is a jig that presses the product region 4a in the work region toward the placing table 5, and is attached to a fixing plate 81 of the support portion 8. The support portion 8 includes a fixing plate 81, a support plate 82, and a fastening portion 83 each extending in a substantially horizontal direction. A coupling portion 810 extends upward from the fixing plate 81, and an upper end portion of the coupling portion 810 is attached to the support plate 82 by screwing a bolt 800 into a screw hole of the fastening portion 83. More specifically, the support plate 82 is sandwiched between the coupling portion 810 and the fastening portion 83 by fastening the bolt 800. As a result, the fixing plate 81 to which the inner periphery pressing portion 6 is attached is fixed to the support plate 82. The support plate 82 is provided with a sealing material 801 that seals an upper space and a lower space SP2 of the support plate 82. The support portion 8 is biased downward by a spring 85, and is supported to be slidable in the up-down direction with respect to the upper part 3 against the biasing force of the spring 85. The bolt 800, the spring 85, and the like constitute a support portion 8A (first support portion) that supports the inner periphery pressing portion 6 so as to be movable in the up-down direction.

A blow gas (for example, air) is supplied to the space SP2 between the cutting blade 2 and the support plate 82 by a blow device 10 provided separately from the cutting apparatus 1. A space SP3 between the cutting blade 2 and the fixing plate 81 communicates with the space SP2 via an opening 200 formed in the cutting blade 2, that is, the opening 200 penetrating the cutting blade 2 in the up-down direction. Therefore, the blow gas is also supplied from the space SP2 to the space SP3 between the cutting blade 2 and the fixing plate 81. The coupling portion 810 of the support portion 8 is inserted into the opening 200.

A plurality of suction flow paths 60 connected to the suction device 9 are formed between the inner periphery pressing portion 6 and the fixing plate 81. The lower surface 61 of the inner periphery pressing portion 6 is provided with a plurality of suction holes 600 penetrating the inner periphery pressing portion 6 in the up-down direction. The suction flow path 60 and the lower space of the inner periphery pressing portion 6 communicate with each other via the suction holes 600, and by performing suction with the suction device 9 through the suction hole 600, the workpiece 4 can be adsorbed onto the lower surface 61 of the inner periphery pressing portion 6.

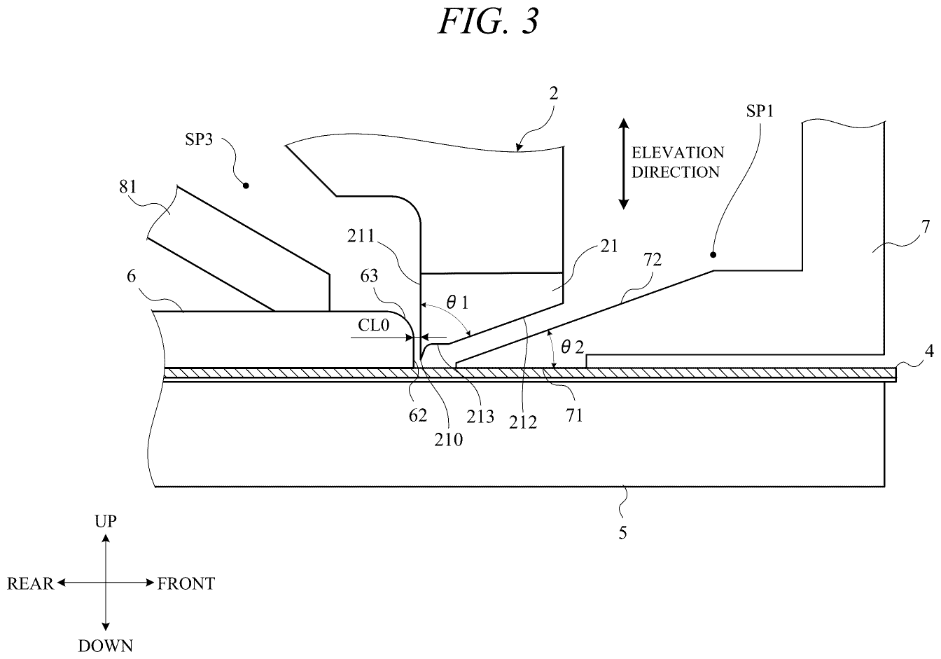

FIG. 3 is an enlarged view of the blade portion 21 of FIG. 2. As illustrated in FIG. 3, the blade portion 21 includes a distal end 210 which is a lower end protruding downward, a blade surface 211 formed on the inner periphery pressing portion side, and a blade surface 212 formed on the outer periphery pressing portion side. The distal end 210 is also referred to as a tip end 210. The blade surface 211 extends upward from the distal end 210, that is, in the elevation direction of the blade portion 21. The blade surface 212 includes a blade surface 213 in the vicinity of the distal end 210. The blade surface 213 extends with a steep upward gradient from the distal end 210 toward the front, and then extends substantially horizontally to the front. The blade surface 212 extends obliquely with a gentle upward gradient toward the front. The blade surface 211 and the blade surface 212 are formed such that an angle θ1 formed by the blade surface 211 and the blade surface 212 is an acute angle (θ<90 degrees).

The inner periphery pressing portion 6 has an end surface 62 facing the blade portion 21 and extending in the up-down direction, and an curve surface 63 connected to the upper end of the end surface 62. The blade surface 211 and the end surface 62 are substantially parallel. In the present embodiment, a clearance CL0 of a gap between the end surface 62 and the blade surface 211 is set to about 0.1 mm. The outer periphery pressing portion 7 has an inclined surface 72 facing the blade surface 212 of the blade portion 21. In the present embodiment, an angle θ2 formed by the inclined surface 72 and the lower surface 71 of the outer periphery pressing portion 7 is substantially equal to an angle (90 degrees−θ1) obtained by subtracting θ1 from 90 degrees. Therefore, the blade surface 212 and the inclined surface 72 are substantially parallel, and a clearance between the blade surface 212 and the inclined surface 72 is substantially constant along the inclined surface 72. The angle θ2 may not be equal to the angle obtained by subtracting θ1 from 90 degrees, but it is preferable that the angle θ2 is substantially equal to the angle obtained by subtracting θ1 from 90 degrees.

Next, a cutting operation and a cutting residue removing process of the cutting apparatus 1 will be described. First, the cutting operation for cutting the workpiece 4 by lowering the blade portion 21 from an elevation upper end position (maximum ascent position) to an elevation lower end position (maximum descent position) will be described. During the operation of the cutting apparatus 1 in which cutting is repeatedly performed, a blow gas supply operation by the blow device 10 and a suction operation by the suction device 9 are constantly performed.

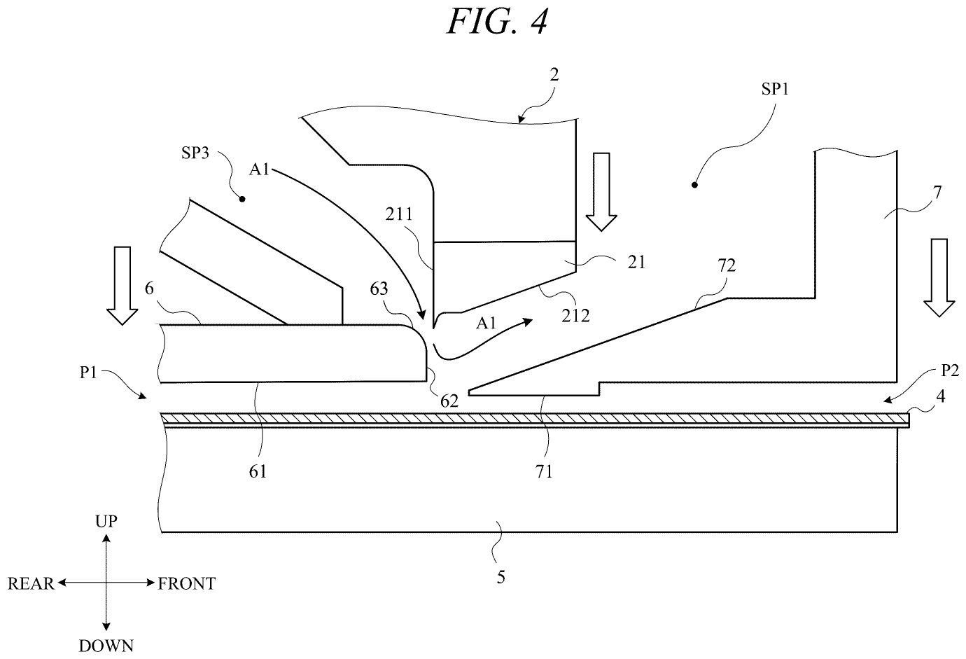

FIG. 4 is a view illustrating a state where the blade portion 21 is located at the elevation upper end position. At this time, the inner periphery pressing portion 6 is located at a first initial position P1, and the outer periphery pressing portion 7 is located at a second initial position P2. As illustrated in FIG. 4, the workpiece 4 is placed on the placing table 5. When the blade portion 21 is located at the elevation upper end position, that is, when the outer periphery pressing portion 7 and the inner periphery pressing portion 6 are biased downward at the maximum by the springs 702 and 85, the inner periphery pressing portion 6 and the outer periphery pressing portion 7 are supported such that the lower surface 71 of the outer periphery pressing portion 7 is located below the lower surface 61 of the inner periphery pressing portion 6. In other words, the inner periphery pressing portion 6 and the outer periphery pressing portion 7 are supported such that the first initial position P1 is located above the second initial position P2. Since the space SP1 is sucked by the suction device 9, the blow gas supplied to the space SP3 flows to the space SP1 through the gap between the blade surface 212 and the inclined surface 72 as indicated by an arrow A1 in FIG. 4.

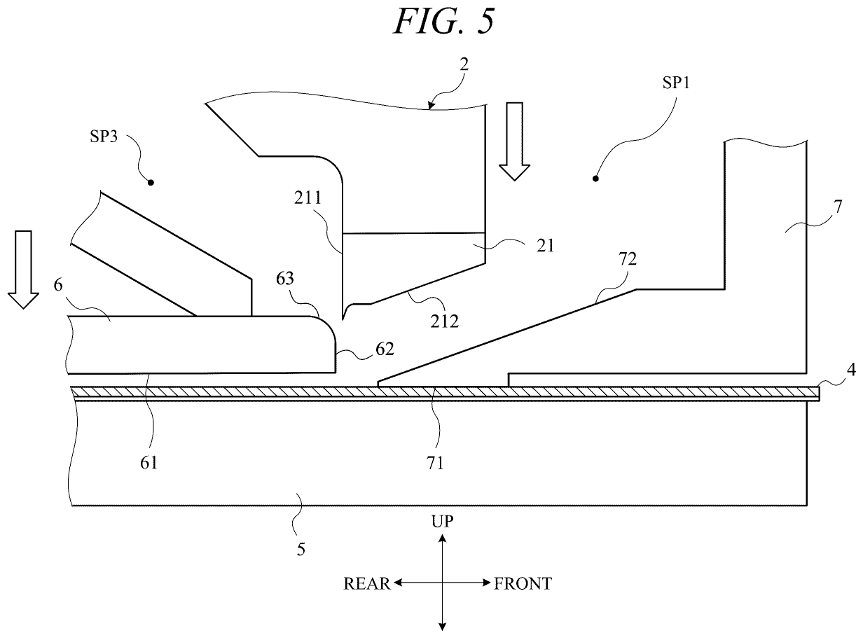

When the blade portion 21 is lowered by starting the downward movement of the upper part 3 from the state illustrated in FIG. 4, the inner periphery pressing portion 6 and the outer periphery pressing portion 7 attached to the upper part 3 are also lowered integrally. Then, as illustrated in FIG. 5, the lower surface 71 of the outer periphery pressing portion 7 comes into contact with the workpiece 4. At this time, the lower surface 61 of the inner periphery pressing portion 6 is separated from the workpiece 4.

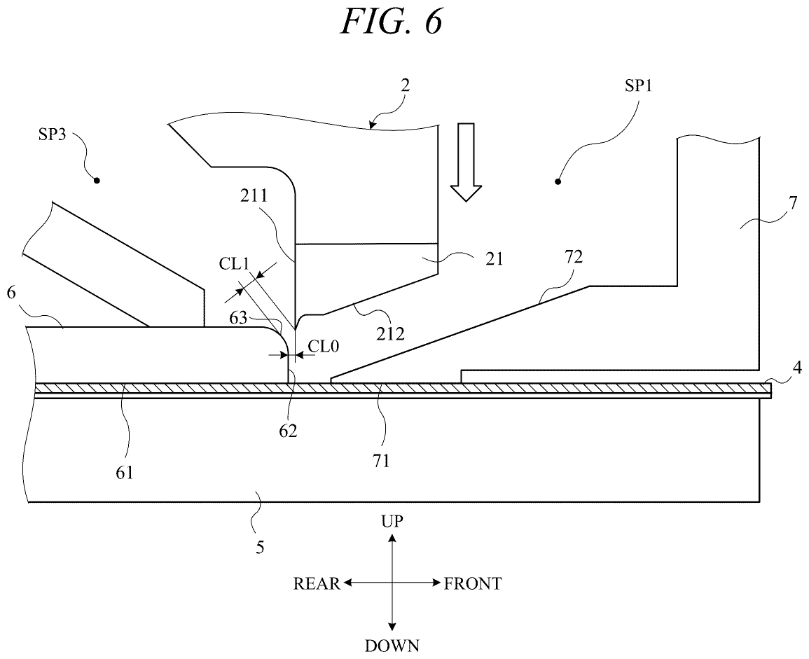

When the upper part 3 further moves downward from the state illustrated in FIG. 5, the blade portion 21 and the inner periphery pressing portion 6 is further lowered. On the other hand, as for the outer periphery pressing portion 7 in contact with the workpiece 4, the spring 702 (FIG. 2) contracts, so that the position of the outer periphery pressing portion 7 in the elevation direction is maintained constant in the state of pressing the workpiece 4 downward. Furthermore, when the upper part 3 moves downward, the lower surface 61 of the inner periphery pressing portion 6 comes into contact with the workpiece 4 as illustrated in FIG. 6, and suction via the suction hole 600 (see FIG. 2) of the inner periphery pressing portion 6 is started. Here, a clearance CL1 between the distal end of the blade portion 21 and the inner periphery pressing portion 6 when the blade portion 21 illustrated in FIG. 6 is located at the elevation upper end position, is larger than the clearance CL0 (about 0.1 mm) of the gap between the end surface 62 and the blade surface 211 by forming the curve surface 63.

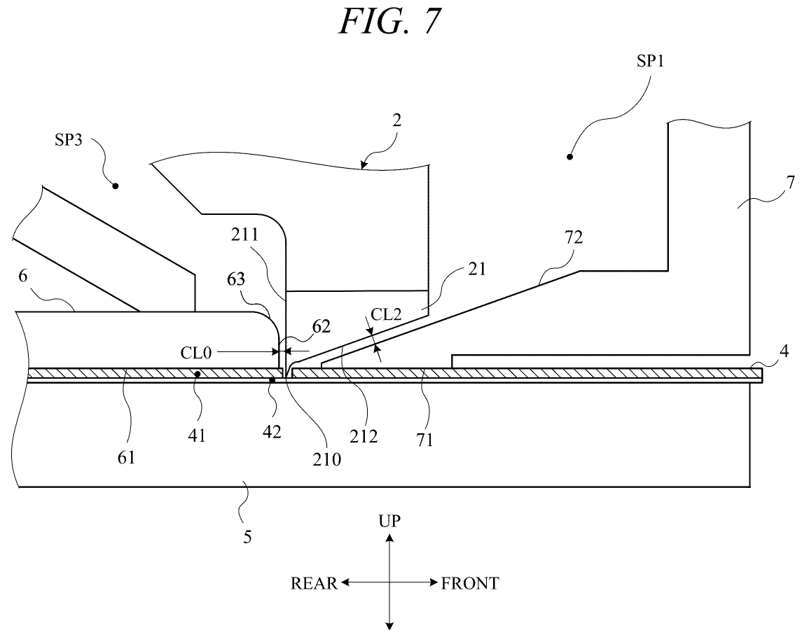

When the upper part 3 is further moved downward from the state of FIG. 6, the blade portion 21 is further lowered. On the other hand, the spring 85 (FIG. 2) biasing the inner periphery pressing portion 6 downward contracts, so that the position of the inner periphery pressing portion 6 in the elevation direction is maintained constant in the state of pressing the workpiece 4 downward. As illustrated in FIG. 7, when the blade portion 21 is lowered to the elevation lower end position, the CP material 41 of the workpiece 4 is cut by the distal end 210 of the blade portion 21, and the distal end 210 is stuck in a carrier film 42. A clearance CL2 between the inclined surface 72 and the blade surface 212 when the blade portion 21 is located at the elevation lower end position, is set to be larger than the clearance CL1 (about 2 mm).

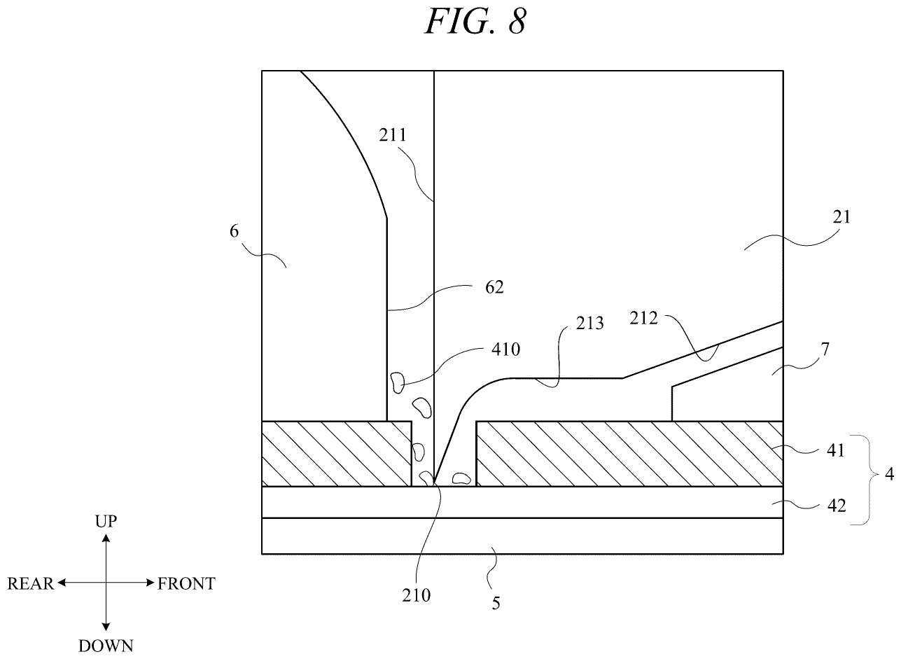

Next, the cutting residue removing process will be described. FIG. 8 is an enlarged view of a cutting location in the cut state illustrated in FIG. 7. When the CP material 41 is cut, a cutting residue 410 is generated at that time. The generated cutting residue 410 adheres to the cut surface of the CP material 41, the end surface 62 of the inner periphery pressing portion 6, the carrier film 42, a region in the vicinity of the distal end 210 of the blade portion 21 (for example, the blade surface 211 and the like), and the like.

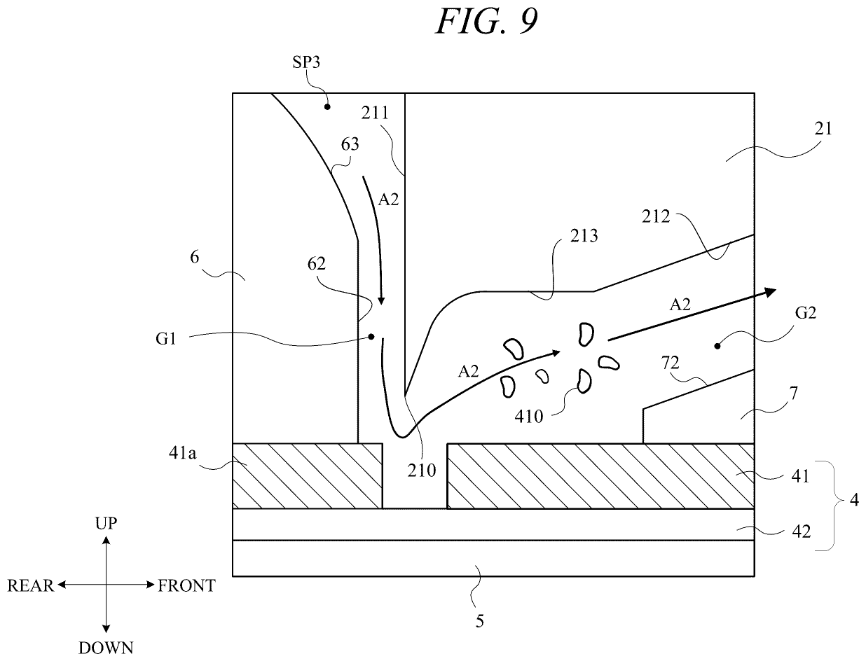

After the workpiece 4 is cut by lowering the blade portion 21 to the elevation lower end position, the upper part 3 is moved upward to raise the blade portion 21. FIG. 9 is an enlarged view of the blade portion 21 when the blade portion 21 starts to rise and enters the state illustrated in FIG. 3. When the blade portion 21 starts to rise and the distal end 210 of the blade portion 21 is separated from the carrier film 42, as illustrated in FIG. 9, a gap G1 between the blade surface 211 and the end surface 62 of the inner periphery pressing portion 6 and a gap G2 between the blade surface 212 and the inclined surface 72 of the outer periphery pressing portion 7 communicate with each other. As a result, as indicated by an arrow A2, the blow gas in the space SP3 (see FIG. 3) flows through the gap G1, circulates around the distal end 210 of the blade portion 21, and then flows toward the gap G2 and flows into the space SP1 (see FIG. 3).

As illustrated in FIG. 7, in a state where the blade portion 21 is located at the elevation lower end position, the distal end 210 of the blade portion 21 is stuck in the carrier film 42, so that the gap G2 does not communicate with the gap G1. Therefore, the gap G2 and the space SP1 communicating with the suction flow path 31 are in a negative pressure state. As a result, when the distal end 210 of the blade portion 21 is separated from the carrier film 42, the blow gas in the space SP3 vigorously flows into the gap G2.

Such a setting that the clearance CL0 of the gap G1 is smaller (considerably smaller) than the other clearances CL1 and CL2 creates a synergistic effect with the gap G2 in a negative pressure state, and the flow velocity of the blow gas flowing through the gap G1 becomes high. In addition, since the gap G2 is sucked by the suction device 9, the flow of the blow gas flows only in one direction from the gap G1 to the gap G2. As a result, the cutting residue 410 adhering to the end surface 62 of the inner periphery pressing portion 6, the carrier film 42, the blade surface 211, and the like is blown off by the high-speed blow gas, and flows into the space SP1 through the gap G2 along the flow (arrow A2) of the blow gas.

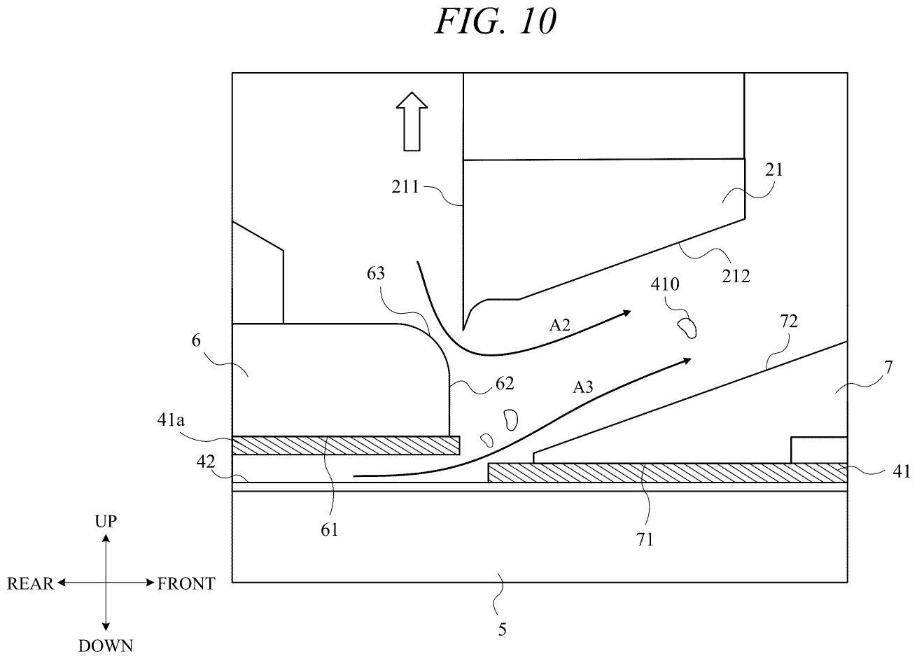

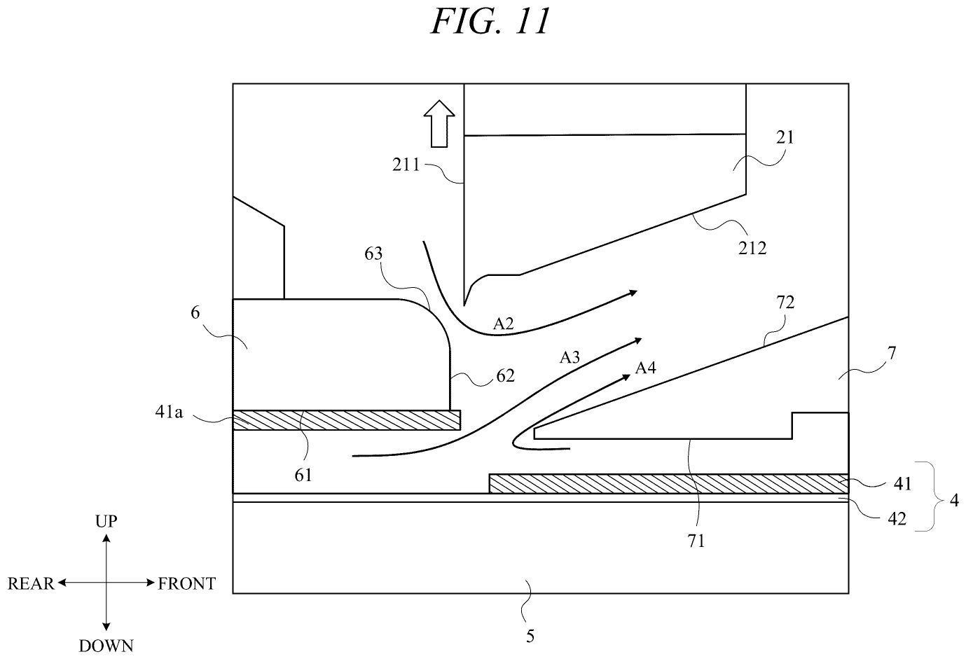

When the upper part 3 moves upward from the state illustrated in FIGS. 3 and 9, the blade portion 21 rises to pass through the state illustrated in FIG. 5, and further the inner periphery pressing portion 6 rises from the position illustrated in FIG. 3. As a result, as illustrated in FIG. 10, the CP material (that is, a cut product CP41a) in the adsorbed state on the lower surface 61 of the inner periphery pressing portion 6 is peeled off from the carrier film 42. FIG. 10 is an enlarged view of the blade portion 21 and the periphery thereof in the state illustrated in FIG. 5 in the rising procedure. As described above, when the cut product CP41a is adsorbed onto the lower surface 61 of the inner periphery pressing portion 6 and rises, the blow gas also flows into the gap between the product CP41a and the carrier film 42 as indicated by an arrow A3, and the cutting residue 410 adhering to the cut surface is blown off in the direction of the gap G2 and the space SP1. FIG. 11 is an enlarged view of the blade portion 21 and the periphery thereof in a state where the blade portion 21 rises to the elevation upper end position. When the upper part 3 further moves upward from the state illustrated in FIG. 10 and the lower surface 71 of the outer periphery pressing portion 7 is separated from the workpiece 4 as illustrated in FIG. 11, as indicated by an arrow A4, air outside the apparatus flows in through a gap between the lower surface 71 of the outer periphery pressing portion 7 and the workpiece 4 (a scrap portion not used as the product) below the lower surface.

According to the present embodiment, the following operations and effects are achievable.

(1) As illustrated in FIGS. 2, 12, and the like, the cutting apparatus 1 includes: the placing table 5 on which the plate-shaped (sheet-shaped) workpiece 4 is placed; the inner periphery pressing portion 6 (first workpiece pressing portion) that presses the product region 4a (first workpiece region) of the workpiece 4 toward the placing table 5; the outer periphery pressing portion 7 (second workpiece pressing portion) that is provided to be separated from the inner periphery pressing portion 6 in an extending direction of the workpiece 4 and presses the excess region 4c (second workpiece region) of the workpiece 4 toward the placing table 5; and the blade portion 21 that moves up and down between the inner periphery pressing portion 6 and the outer periphery pressing portion 7 in a plate thickness direction of the workpiece to cut the workpiece 4. The blade portion 21 includes the blade surface 211 (first blade surface) extending in the elevation direction from the distal end 210 of the blade portion 21 and facing the inner periphery pressing portion 6, and the blade surface 212 (second blade surface) extending along the outer periphery pressing portion 7 from the distal end 210 of the blade portion 21 and facing the outer periphery pressing portion 7.

The cutting blade 2, the fixing plate 81, and the inner periphery pressing portion 6 forming the space SP3 and the gap G1 (FIG. 9) function as a part of a blow part that constantly supplies a blow gas from the gap G1 between the blade surface 211 and the inner periphery pressing portion 6 to a region around the distal end of the blade portion 21. The suction flow path 31 connected to the suction device 9, and the blade portion 21 and the outer periphery pressing portion 7 forming the space SP1 and a gap G2 function as a part of a suction part that constantly sucks the gas in the region around the distal end of the blade portion 21 and the region of a blade surface 212. As a result, the blow gas flows in one direction from the gap G1 facing the blade surface 211 to the gap G2 facing the blade surface 212 through the periphery of the distal end 210 of the blade portion 21. The cutting residue 410 is blown off along the flow of the blow gas toward the outer periphery pressing portion 7 that presses the excess region 4c of the workpiece 4. Therefore, the cutting residue 410 can be reliably prevented from adhering to the blade surface 211, and the cutting residue 410 can be prevented from falling from the blade surface 211 to the product region 4a.

(2) As illustrated in FIG. 3, the inner periphery pressing portion 6 has the end surface 62 (first end surface) facing the first blade surface 211 with a predetermined clearance CL0 (first clearance) when the blade portion 21 moves up and down. As illustrated in FIG. 6, the clearance CL0 is set to be smaller than the clearance CL1 between the distal end 210 of the blade portion 21 and the inner periphery pressing portion 6 when the blade portion 21 is located at the elevation upper end position (maximum ascent position). As a result, the flow velocity of the blow gas in the gap G1 increases at the time of cutting the workpiece 4, and the flow of the gas can be maintained in one direction (A2 direction in FIG. 9). Note that in the example illustrated in FIG. 6, the clearance CL1 is made larger than the clearance CL0 by forming the curve surface 63 connected to the upper end of the end surface 62, but a planar chamfered shape may be used instead of the curve surface 63.

(3) As illustrated in FIG. 7, the outer periphery pressing portion 7 has the inclined surface 72 which is a surface (opposing surface) facing the second blade surface 212 of the blade portion 21, and the clearance CL2 (second clearance) between the blade surface 212 and the inclined surface 72 when the blade portion 21 is located at the elevation lower end position (maximum descent position) is set to be larger than the clearance CL0. Therefore, even at the elevation lower end position, the gap G2 can be maintained in a negative pressure state by being sucked by the suction device 9. As a result, when the blade portion 21 rises from the elevation lower end position, it is possible to constantly generate a gas flow in the A2 direction without a gas backflow (the flow opposite to the arrow A2).

(4) The blade portion 21 that cuts the workpiece 4 is a trimming blade portion that removes the excess region 4c (excess workpiece region) from the workpiece 4 to form the product region 4a (product workpiece region), the inner periphery pressing portion 6 presses the product region 4a, and the outer periphery pressing portion 7 presses the excess region 4c. Therefore, the gas to be blown and sucked flows from the product region 4a side to the excess region 4c side as indicated by the arrow A2 in FIG. 9, and the cutting residue 410 can be prevented from adhering to the product region 4a side.

(5) As illustrated in FIG. 3, since the angle θ1 formed by the first blade surface 211 and the second blade surface 212 is set to an acute angle, the gap G1 through which the blow gas flows and the gap G2 in which suction is performed by the suction device 9 communicate with each other at an acute angle, and it is possible to effectively remove the cutting residue 410 without reducing the flow velocity of the gas.

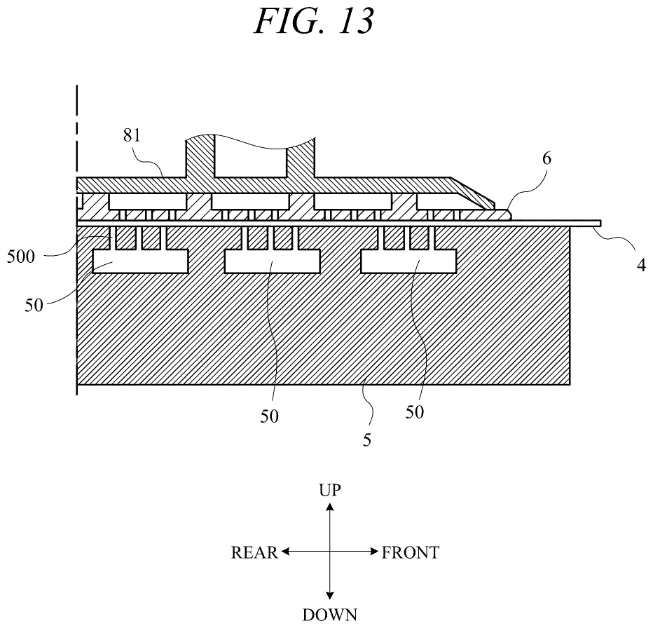

(6) In the example illustrated in FIG. 2, the suction flow path 60 and the suction hole 600 are provided in the inner periphery pressing portion 6 as a part of an adsorption part, and the workpiece 4 is adsorbed onto the lower surface 61 of the inner periphery pressing portion 6. However, the present invention is not limited to such a configuration, and as illustrated in FIG. 13, a suction flow path 50 and a suction hole 500 may be provided on the placing table 5 side to adsorb the workpiece 4 onto the mounting surface of the placing table 5. The adsorption part may be provided in both the inner periphery pressing portion 6 and the placing table 5.

The above embodiment can be combined as desired with one or more of the above modifications. The modifications can also be combined with one another.

According to the present invention, it is possible to prevent a cutting residue from falling on a workpiece.

Above, while the present invention has been described with reference to the preferred embodiments thereof, it will be understood, by those skilled in the art, that various changes and modifications may be made thereto without departing from the scope of the appended claims.

What is claimed is:

1. A cutting apparatus comprising:
a placing table on which a workpiece formed in a plate shape is placed;
a first workpiece pressing portion configured to press a first workpiece region of the workpiece toward the placing table;
a second workpiece pressing portion provided to be separated from the first workpiece pressing portion in an extending direction of the workpiece and configured to press a second workpiece region of the workpiece toward the placing table; and
a blade portion configured to move up and down in a predetermined direction corresponding to a thickness direction of the workpiece between the first workpiece pressing portion and the second workpiece pressing portion to cut the workpiece, wherein
the blade portion includes
a first blade surface extending in the predetermined direction from a distal end of the blade portion and facing the first workpiece pressing portion, and
a second blade surface extending along the second workpiece pressing portion from the distal end of the blade portion and facing the second workpiece pressing portion,
the cutting apparatus further comprises:
a blow part configured to supply a blow gas to a region around the distal end of the blade portion through a gap between the first blade surface and the first workpiece pressing portion; and
a suction part configured to suck a gas in the region around the distal end of the blade portion through a gap between the second blade surface and the second workpiece pressing portion.

2. The cutting apparatus according to claim 1, wherein
the first workpiece pressing portion includes a first end surface facing the first blade surface with a first clearance when the blade portion moves up and down, and
the first clearance is smaller than a clearance between the distal end of the blade portion and the first workpiece pressing portion when the blade portion is positioned at a maximum ascent position of the blade portion.

3. The cutting apparatus according to claim 2, wherein
the second workpiece pressing portion includes an opposing surface facing the second blade surface of the blade portion,
a clearance between the second blade surface and the opposing surface is a second clearance, and
the second clearance is larger than the first clearance when the blade portion is positioned at a maximum decent position of the blade portion.

4. The cutting apparatus according to claim 3, wherein
the second blade surface is configured to be substantially parallel to the opposing surface.

5. The cutting apparatus according to claim 1, wherein
the blade portion is a trimming blade portion configured to remove an excess workpiece region, corresponding to the second workpiece region, from the workpiece to form a product workpiece region corresponding to the first workpiece region.

6. The cutting apparatus according to claim 1, wherein
an angle formed between the first blade surface and the second blade surface is set to an acute angle.

7. The cutting apparatus according to claim 1, wherein
at least one of the placing table and the first workpiece pressing portion includes an adsorption part to adsorb the workpiece.

8. The cutting apparatus according to claim 1, further comprising:
a first support portion configured to movably support the first workpiece pressing portion in the predetermined direction; and
a second support portion configured to movable support the second workpiece pressing portion in the predetermined direction, wherein
the first support portion includes a first biasing portion configured to bias the first workpiece pressing portion toward the workpiece, and
the second support portion includes a second biasing portion configured to bias the second workpiece pressing portion toward the workpiece.

9. The cutting apparatus according to claim 8, wherein
the first support portion and the second support portion are configured to support the first workpiece pressing portion and the second workpiece pressing portion, respectively, so that a first initial position, before the first workpiece pressing portion comes into contact with the workpiece, is positioned above a second initial position, before the second workpiece pressing portion comes into contact with the workpiece.
